(19) United States
(12) Patent Application Publication
(10) Pub. No.: US 2023/0170555 A1
(43) Pub. Date: Jun. 1, 2023

(54) CONNECTION MEANS FOR ELECTROCHEMICAL CELL

(71) Applicant: ILIKA TECHNOLOGIES LTD, Romsey (GB)

(72) Inventors: Sara AGHDAEI, Southhampton (GB); Ali KHIAT, Southampton (GB); Thomas RISBRIDGER, Southampton (GB); Thomas FOLEY, Southampton (GB); Hugo JUNGIUS, Southhampton (GB); Louise TURNER, Salisbury, Wiltshire (GB)

(21) Appl. No.: 17/997,373

(22) PCT Filed: Apr. 27, 2021
(86) PCT No.: PCT/GB2021/051016

§ 371 Date: Oct. 28, 2022

(30) Foreign Application Priority Data
Apr. 30, 2020 (GB) 2006391.3

(51) Int. Cl. H01M 50/129; H01M 50/172; H01M 50/562; H01M 50/534; H01M 50/121; H01M 50/119; H01M 50/117; H01M 50/131; H01M 10/0525; H01M 10/058

(52) U.S. Cl. CPC H01M 50/129; H01M 50/172; H01M 50/562; H01M 50/534; H01M 50/121; H01M 50/119; H01M 50/117; H01M 50/131; H01M 10/0525; H01M 10/058

(57) ABSTRACT

An electrochemical cell comprises at least the following layers stacked in the following order: a first electrode layer, an electrolyte layer, a second electrode layer, a current collector layer, and a protective cover; the protective cover comprising an electrically-insulating material. The cell further comprises an electrically-conductive contact pad that is configured to enable connection of the cell to external devices, the contact pad being provided on an external side of the protective cover that is opposed to the current collector layer, and comprising an exposed surface that is bounded about its perimeter by the electrically-insulting material. An electrically-conductive pathway is provided between the contact pad and the current collector layer, the electrically-conducive pathway extending through the protective cover and contacting a face of the current collector layer at a connection site.

### FIELD OF THE INVENTION

The present invention relates to means for connecting an electrochemical cell to an external device, and methods for the production of such means.

### BACKGROUND TO THE INVENTION

A thin film electrochemical cell typically comprises a stack of layers supported on a substrate and arranged in the following order: a first electrode layer proximal to the substrate, an electrolyte layer, a second electrode layer, and a current collector layer distal from the substrate. The stack of layers is generally covered by an encapsulating layer, which serves to help shield the stack of layers from atmospheric constituents such as moisture and/or oxygen.

Other layers may be present in the electrochemical cell: for example, an electrically-insulating passivation layer may be provided between the current collector layer and the encapsulating layer, and/or a further current collector may be provided between the substrate and the first electrode layer.

In certain cases, the electrochemical cell is a solid state cell, that is, the electrolyte layer is provided by a solid state electrolyte. In other cases, the electrolyte layer may comprise a porous separator that is impregnated with a liquid or polymer electrolyte.

In certain cases, the electrochemical cell may be a rechargeable cell, also known as a secondary cell. In such cases, the cell may be a lithium-ion cell, in which at least one of the first electrode layer, the second electrode layer and the electrolyte layer is provided by a lithium-containing compound, and the process of charging and discharging the cell involves the migration of lithium ions between the two electrodes.

In the case that the electrochemical cell is a lithium-ion cell, one of the first and second electrode layers may be provided by a layer of lithium and may be first formed during the initial charging cycle of the cell.

In order to connect the electrochemical cell to an external device, it is necessary to provide an electrical connection between the first electrode and the device, and a further electrical connection between the second electrode and the device.

In the case that a further current collector layer is present between the substrate and the first electrode layer, the further current collector layer may have a portion that remains uncovered by the encapsulating layer, to provide a contact pad that allows connection of the further current collector layer to the external device. In other cases, the substrate may be electrically conductive, thus allowing an electrical connection between the first electrode and the external device to be provided via the substrate.

In general, the current collector layer that is distal from the substrate has a region that remains uncovered by the encapsulating layer, so as to allow connection of that current collector layer to the external device, to complete an electrical circuit comprising the cell and the device.

It is desirable to configure the cell so that a reliable connection may be formed between the external device and the current collector layer that is distal to the substrate.

### SUMMARY OF THE INVENTION

In certain cases, it has been attempted to provide an electrically-conductive track layer over the outer surface of the encapsulation layer, such a track layer serving to provide a conductive path between the substrate and the uncovered portion of the current collector layer that is distal to the substrate. In such cases, the track layer may allow a further contact pad to be provided on the substrate, so as to allow an electrical connection to be provided between the current collector that is distal to the substrate and an external device. However, it is thought that such a track layer may not be sufficiently mechanically robust to withstand changes in the thickness of the first and/or second electrode layers that occur as a result of the migration of charged species (such as lithium ions) during operation of the cell. In the case that the cell is a secondary cell, the first and/or second electrode layers may undergo multiple cycles of swelling and contraction, as the cell is alternately charged and discharged.

Other techniques to make the required electric connection between the current collector layer that is distal to the substrate and the external device have been attempted, such as wire-bonding of a conductive element to the exposed portion of the current collector layer. However, it is thought that in such cases, reaction products may be formed at the exposed surface of the current collector layer during operation of the cell. These reaction products have been found to impede the bonding between the wire and the current collector layer, such that electrical contact may be lost after only a few cycles of the cell. It is thought that the formation of these reaction products may be due to diffusion of species from the first electrode layer, the second electrode layer and/or the electrolyte layer towards the exposed surface of the current collector layer that is distal to the substrate.

In a first aspect, the present invention may provide an electrochemical cell comprising at least the following layers stacked in the following order:
a first electrode layer, an electrolyte layer, a second electrode layer, a current collector layer, and a protective cover;
the protective cover comprising an electrically-insulating material;
the cell further comprising an electrically-conductive contact pad that is configured to enable connection of the cell to external devices, the contact pad being provided on an external side of the protective cover that is opposed to the current collector layer, and comprising an exposed surface that is bounded about its perimeter by the electrically-insulating material;
wherein an electrically-conductive pathway is provided between the contact pad and the current collector layer, the electrically-conductive pathway extending through the protective cover and contacting a face of the current collector layer at a connection site.

In certain cases, the contact pad is configured to allow wire-bonding of a conductive element to provide electric connection of the current collector layer to an external device. However, in other cases, the contact pad may be configured to allow electrical connection to the external device to be provided through other means, such as reflow soldering or the provision of conductive epoxy or conductive ink.

It is thought that by providing a contact pad that is displaced from the current collector layer, the extent of diffusion of species from the first electrode layer, the second electrode layer and/or the electrolyte layer to the contact pad may be reduced. This is thought to help prevent the formation of reaction products at the contact pad, which are thought to impede the bonding required to connect the cell to an external device.

Typically at least a portion of the electrically-conductive pathway extends in a direction that is not perpendicular to the face of the current collector layer.

In general, at least a portion of the electrically-conductive pathway is oriented at an angle of 80° or less relative to the face of the current collector layer. In certain cases, at least a portion of the electrically-conductive pathway is oriented at an angle of 50° or less relative to the face of the current collector layer. In certain cases, at least a portion of the electrically-conductive pathway is aligned with the face of the current collector layer.

Typically, the contact pad is offset from the connection site in a lateral direction with respect to the current collector layer.

In general, the electrically-conductive pathway follows an indirect route between the connection site and the contact pad. For example, the electrically-conductive pathway may change direction through an angle in the range 80-100° between the connection site and the contact pad.

Typically, the electrically-conductive pathway follows a tortuous path between the connection site and the contact pad. For example, the electrically-conductive pathway may follow a zigzag route between the connection site and the contact pad.

The exposed surface of the contact pad may be, for example, circular, oval, polygonal (for example, square, rectangular, or hexagonal), or any other two-dimensional shape.

Typically, the electrically-conductive pathway and the contact pad are integrally formed. However, this is not always the case.

In certain cases, at least one of the electrically-conductive pathway and the contact pad comprises a material selected from the group consisting of aluminium and titanium nitride. In certain cases, one or both of the electrically-conductive pathway and the contact pad may be provided by the same material as the current collector layer, for example, a material selected from the group consisting of platinum, nickel, molybdenum, copper, titanium nitride, aluminium, gold and stainless steel.

Typically, the electrically-conductive pathway has a thickness in the range 20-2000 nm, wherein the thickness is measured in a transverse direction to the surface of the pathway and the surface of the pathway is effectively a continuation of the exposed surface of the contact pad.

In general, the protective cover comprises a plurality of layers. This is thought to impede ingress of atmospheric constituents such as moisture and/or oxygen into the active layers of the cell. Furthermore, the plurality of layers may help to impede diffusion of species from the first electrode layer, the second electrode layer and/or the electrolyte layer to the contact pad.

The protective cover typically comprises a plurality of first layers and a plurality of second layers, the first layers each being provided by a polymeric material and the second layers each being provided by one of a metal and a ceramic material, wherein the first and second layers are arranged in a stacked configuration to provide alternating first and second layers.

Typically, at least one of the first layers has a thickness in the range 1-10 μm, for example, 3-7 μm. Typically, at least one of the second layers has a thickness in the range 20-2000 nm, for example, 100-500 nm.

In certain cases in which at least one of the second layers is provided by an electrically-conductive material, a portion of the electrically-conductive pathway may extend along that layer.

In other cases in which at least one of the second layers is provided by an electrically-conductive material, the electrically-conductive pathway may be electrically insulated from that layer.

In certain cases, at least one of the first layers may comprise a poly(p-xylylene) polymer, such as parylene™.

In other cases, at least one of the first layers comprises a photoresist material, for example a photoresist material comprising an epoxy resin. This may allow the layer to be patterned directly, by exposing the layer to a pattern of light that causes chemical changes within certain portions of the layer, followed by the application of a solvent that provides selective removal of the layer, depending on the pattern of light that has been applied.

In certain cases, at least one of the second layers comprises a material selected from the group comprising aluminium and titanium nitride. Titanium nitride is considered to provide an effective diffusion barrier to lithium species, and so in the case that the cell is a lithium-ion cell, may be particularly beneficial in hindering the migration of such species from the active cell layers (e.g. the first electrode layer, the second electrode layer and/or the electrolyte layer) to the contact pad. In certain cases, the second layer of the protective cover and the current collector layer are provided by the same material, for example, a material selected from the group consisting of platinum, nickel, molybdenum, copper, titanium nitride, aluminium, gold and stainless steel.

In certain cases, the protective cover may comprise a passivation layer immediately adjacent the current collector layer. The passivation layer is provided by an electrically-insulating material that may be selected from the group comprising ceramics, inorganic oxides and complex inorganic oxides. For example, the passivation layer may be selected from the group consisting of aluminium oxide, silicon oxide, silicon nitride, tantalum oxide, hafnium oxide, tungsten oxide, titanium oxide, zinc oxide, zirconium oxide, molybdenum oxide and aluminium nitride. The passivation layer typically has a thickness in the range 100 nm-5 μm.

Typically, a substrate is provided on the side of the first electrode layer that is distal from the electrolyte layer. In certain cases, a further current collector layer is provided between the substrate and the first electrode layer.

In certain cases, at least one further electrically-conductive pathway is provided between the contact pad and the connection site.

In certain cases, the cell comprises a plurality of electrically-conductive pathways, each pathway being associated with a respective connection site at which the pathway contacts the current collector layer, and each pathway extending through the protective cover to reach one of one or more contact pads that are provided on the side of the protective cover that is opposed to the current collector layer.

In certain cases, the cell comprises a plurality of contact pads provided on the side of the protective cover that is opposed to the current collector layer, each of the plurality of contact pads being associated with a respective electrically-conductive pathway that extends between the respective contact pad and the current collector layer.

These arrangements provide redundancy within the cell, so that the cell may still be electrically connected to an external device even in the case that a single electrically-conductive pathway fails. This is particularly advantageous, since the electrically-conductive pathway typically has a thickness in the range 20-2000 nm, and so failure of the pathway may occur, for example, where the underlying surface changes orientation, such as at an edge or corner.

By providing a contact pad on an external side of the protective cover, the contact pad may be located within the overall footprint of the stack of layers that provide the cell. In such cases, the overall footprint of the cell is not increased by the presence of the contact pad.

Typically, the footprint of the cell, defined as the area of one face of the electrolyte layer, is less than 500 mm², in certain cases less than 400 mm², in certain cases less than 300 mm², and in certain cases less than 200 mm². Effectively, therefore, the footprint of the cell is bounded by the perimeter of the electrolyte layer. In still further cases, the footprint of the cell may be less than 100 mm², for example, less than 50 mm².

One of the first and second electrode layers provides the cathode of the cell, while the other of the first and second electrode layers provides the anode of the cell.

The cathode typically has a thickness in the range 5-40 μm.

The anode typically has a thickness in the range 500 nm to 5 μm.

Typically, the electrolyte layer has a thickness in the range of 1-5 μm. In certain cases, the electrolyte layer has a thickness in the range 2-4 μm.

Typically, the current collector layer has a thickness in the range 100-500 nm. In certain cases, the current collector layer has a thickness in the range 200-400 nm.

In general, at least one of the first electrode and the electrolyte is provided by a lithium-containing compound.

In general, the cell comprises a further contact pad that is electrically-connected to the first electrode, wherein an imaginary line extending directly between the contact pad and the further contact pad passes through at least one of the first electrode, the electrolyte, the second electrode and the current collector. Typically, the further contact pad is an exposed portion of a further current collector, the further current collector layer being in direct contact with the first electrode.

For the avoidance of doubt, the first electrode layer, the electrolyte layer, the second electrode layer, the current collector layer and the protective cover are not necessarily coextensive. For example, in certain embodiments, the perimeter of the first electrode layer may not match the perimeter of the current collector layer. In such cases, for example, the connection site may be located outside the perimeter of the first electrode layer, that is, the connection site does not overlie the first electrode layer. Effectively, the connection site is offset from the first electrode layer in a lateral direction of the first electrode layer. This may assist in reducing migration of deleterious species from the first electrode layer to the connection site, particularly in the case that the first electrode is a lithium-containing electrode, for example, a lithium-containing cathode.

By contrast, the contact pad typically lies within the perimeter of the first electrode layer.

Since the layers are not necessarily coextensive, certain layers, for example, the current collector layer, may not be entirely planar. For the avoidance of doubt, references to the face of the current collector layer, in the context of defining the relative orientations of the electrically-conductive pathway and the face of the current collector layer, relate to the portion of the current collector at the connection site.

In certain cases, the electrochemical cell is a solid state electrochemical cell. In certain cases, the electrochemical cell is a secondary cell.

In certain embodiments of the electrochemical cell according to the first aspect of the invention, the anode is formed in situ during initial charging of the cell.

Therefore, in a second aspect, the present invention may provide a precursor for an electrochemical cell according to the first aspect of the invention, the precursor comprising a stack of layers including a cathode layer, an electrolyte layer, a current collector layer, and a protective cover, the protective cover being located on a first side of the current collector layer, and the cathode layer and electrolyte layer being located on a second side of the current collector layer;
wherein the protective cover comprises an electrically-insulating material;
the cell further comprising an electrically-conductive contact pad that is configured to enable connection of the cell to external devices, the contact pad being provided on an external side of the protective cover that is opposed to the current collector layer, and comprising an exposed surface that is bounded about its perimeter by the electrically-insulating material;
wherein an electrically-conductive pathway is provided between the contact pad and the current collector layer, the electrically-conductive pathway extending through the protective cover and contacting a face of the current collector layer at a connection site.

The cathode may be located between the electrolyte layer and the current collector layer. Alternatively, the cathode may be located on the side of the electrolyte layer that is opposed to the current collector layer.

Typically, initial charging of the precursor results in the formation of a lithium anode layer on the side of the electrolyte layer that is opposed to the cathode layer.

The precursor according to the second aspect of the invention may have one or more of the optional features of the cell of the first aspect of the invention, taken alone or in combination.

In a third aspect, the present invention may provide a method of manufacturing a cell according to the first aspect of the invention, comprising the steps of:
Providing a stack of layers comprising at least the following layers: a cathode layer, an electrolyte layer, a current collector layer, and a first electrically-insulating layer, the first electrically-insulating layer being located on a first side of the current collector layer, and the cathode layer and electrolyte layer being located on a second side of the current collector layer;
Providing an aperture through the thickness of the first electrically-insulating layer, such that a portion of a face of the current collector is exposed; and
Depositing an electrically-conductive material on the exposed section of the current collector layer and at least a portion of the first electrically-insulating layer, so as to create an electrically-conductive pathway between the exposed portion of the face of the current collector layer and the surface of the first electrically-insulating layer that is opposed to the current collector layer.

In general, a passivation layer is provided between the current collector layer and the first electrically-insulating layer, the passivation layer being provided with a respective through-thickness aperture, and the step of providing an aperture through the thickness of the first electrically-insulating layer comprises aligning the aperture in the first electrically-insulating layer with the aperture in the passivation layer.

The passivation layer is provided by an electrically-insulating material that may be selected from the group comprising ceramics, inorganic oxides and complex inorganic oxides. Typically, the passivation layer is provided by a ceramic material selected from the group consisting of: aluminium oxide, aluminium nitride, silicon oxide, silicon nitride, tantalum oxide, hafnium oxide, tungsten oxide, titanium oxide, zinc oxide, zirconium oxide, molybdenum oxide and combinations thereof.

In certain less preferred cases, the first electrically-insulating layer corresponds to such a passivation layer, that is, it is provided by a ceramic material selected from the group consisting of: aluminium oxide, aluminium nitride, silicon oxide, silicon nitride, tantalum oxide, hafnium oxide, tungsten oxide, titanium oxide, zinc oxide, zirconium oxide, molybdenum oxide and combinations thereof.

In general, the step of providing an aperture through the thickness of the first electrically-insulating layer comprises selectively etching the first electrically-insulating layer, for example, through a photolithographic process.

In certain cases, the photolithographic process comprises the step of depositing a photoresist material on the first electrically-insulating layer, for example, through spin-coating. In other cases, before the step of depositing a photoresist material, a metal layer may be deposited on the first electrically-insulating layer, such that the metal layer lies between the photoresist material and the first electrically-insulating layer. In such cases, the photoresist material may be used to pattern the metal layer through a photolithographic process, and the patterned metal layer may subsequently function as a mask in an etching process to provide an aperture in the first electrically-insulating layer.

In further cases, the first electrically-insulating layer comprises a photoresist material, and the step of selectively etching the first electrically-insulating layer may comprise exposing at least one part of the surface of the first electrically-insulating layer to incident light that causes chemical changes within that part of the surface of the first electrically-insulating layer.

Typically, the method according to the third aspect of the invention further comprises the step, after the step of creating the electrically-conductive pathway, of depositing a second electrically-insulating layer over the first electrically-insulating layer and creating a through-thickness aperture through the second electrically-insulating layer, so as to expose a portion of the electrically-conductive pathway. In such cases, the aperture in the second electrically-insulating layer is displaced from the aperture in the first electrically-insulating layer in a lateral direction of the second electrically-insulating layer.

Typically, the first and second electrically-insulating layers are each provided by a polymer material. In certain cases, the first and/or second electrically-insulating layers may comprise a poly(p-xylylene) polymer, such as parylene™. In other cases, the first and/or second electrically-insulating layers comprise a photoresist material, for example a photoresist material comprising an epoxy resin.

Typically, the first and second electrically-insulating layers are each deposited to a thickness in the range 1-10 μm, for example 3-7 μm.

Typically, the electrically-conductive material is deposited to a thickness of 20-2000 nm, for example 100-500 nm. In certain cases, the electrically-conductive material is aluminium. The electrically-conductive material may be deposited through a physical vapour deposition process, such as sputtering. It is preferable that the electrically-conductive material is deposited to a thickness of 2000 nm or less, as this allows the material to be deposited as a layer (for example, through the vapour deposition process), which is subsequently shaped (for example, through etching) to provide the electrically-conductive pathway. If the thickness of the electrically-conductive material is greater than 2000 nm, it may be difficult to remove the unwanted portions of the material fully, so that there is a risk that a short circuit will occur between different parts of the cell.

In certain cases, the stack of layers comprises an anode layer. However, in other cases, the anode layer may be formed during initial charging of the cell.

### DETAILED DESCRIPTION

The invention will now be described by way of example with reference to the following Figures in which:

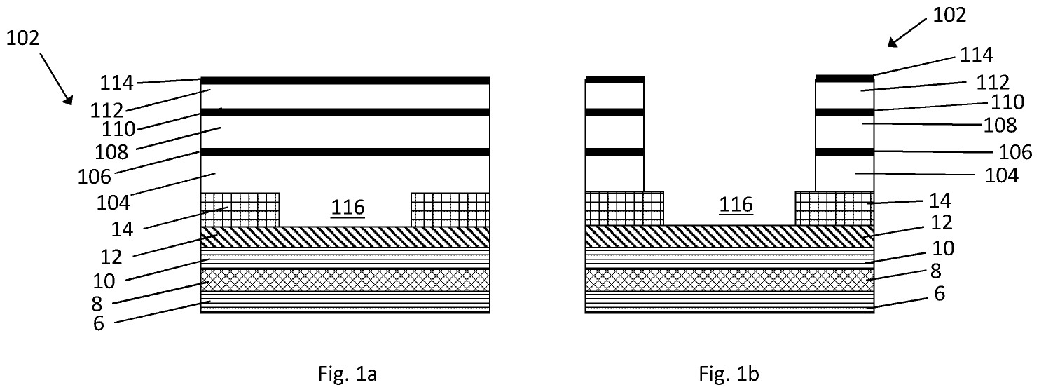

FIGS. 1a and 1b show schematic cross-sectional views of assembled cell components at various stages of manufacture of a cell according to a first comparative example;

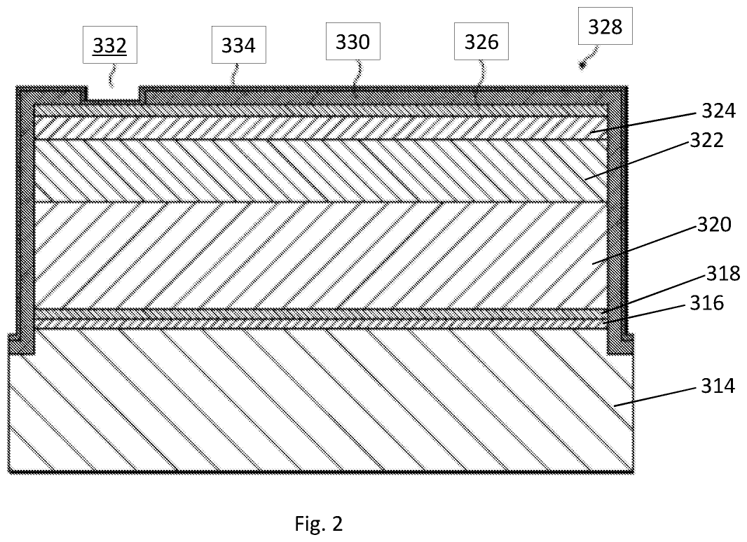

FIG. 2 shows a schematic cross-sectional view of a cell according to a second comparative example;

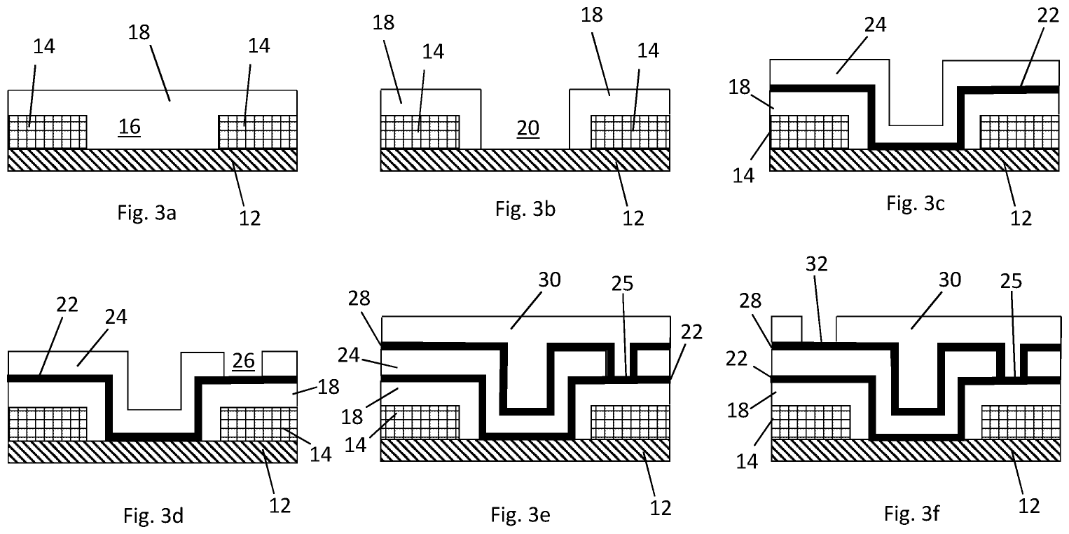

FIGS. 3a to 3f show schematic cross-sectional views of assembled cell components at various stages of manufacture of a cell according to a first embodiment of the first aspect of the invention;

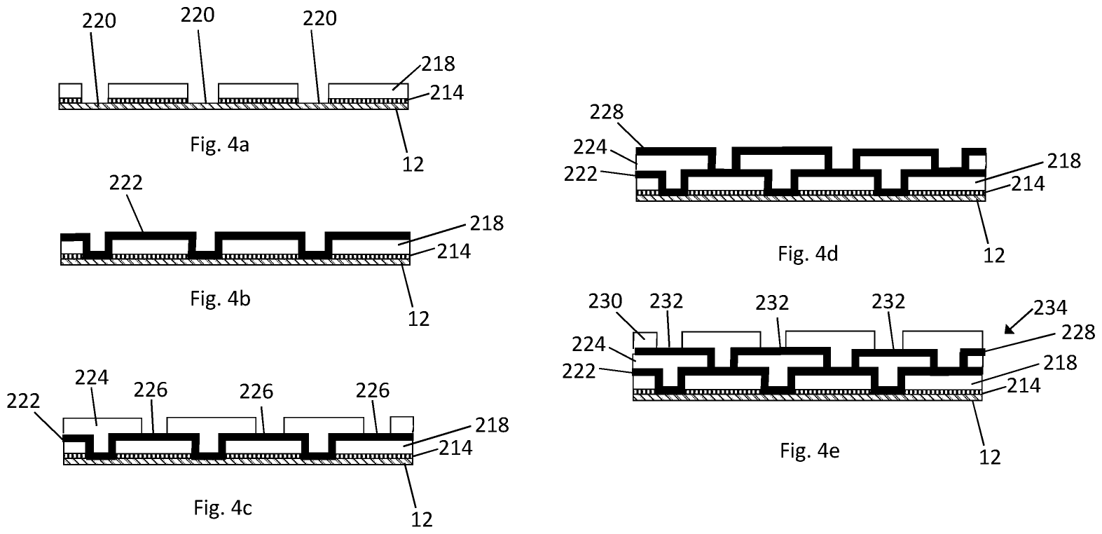

FIGS. 4a to 4e show schematic cross-sectional views of assembled cell components at various stages of manufacture of a cell according to a second embodiment of the first aspect of the invention;

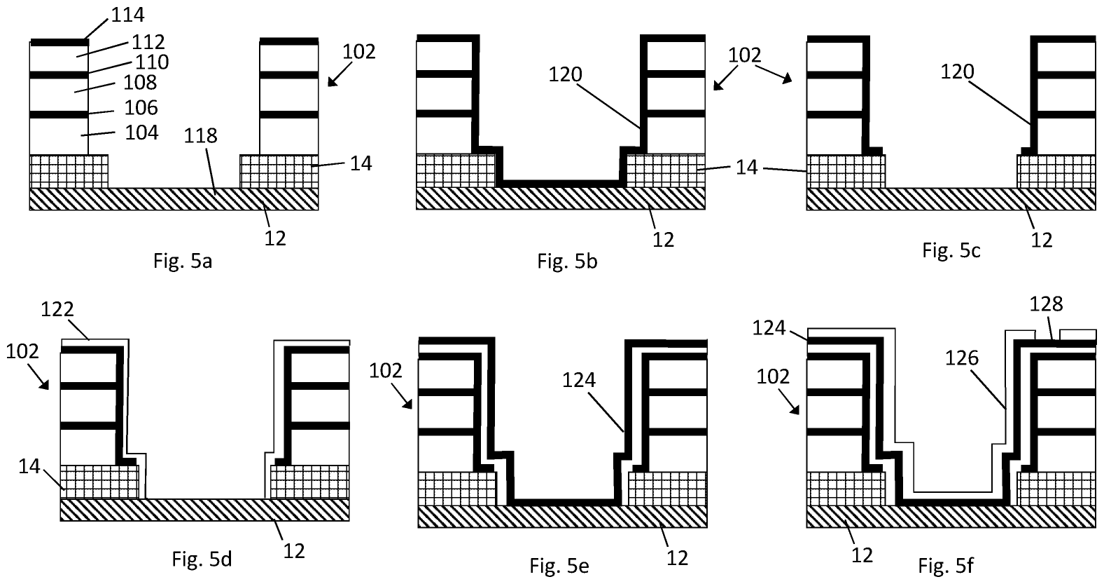

FIGS. 5a to 5e show schematic cross-sectional views of assembled cell components at various stages of a method of adapting the cell manufactured according to the method shown with reference to FIGS. 1a and 1b, so as to provide a cell according to a third embodiment of the first aspect of the invention;

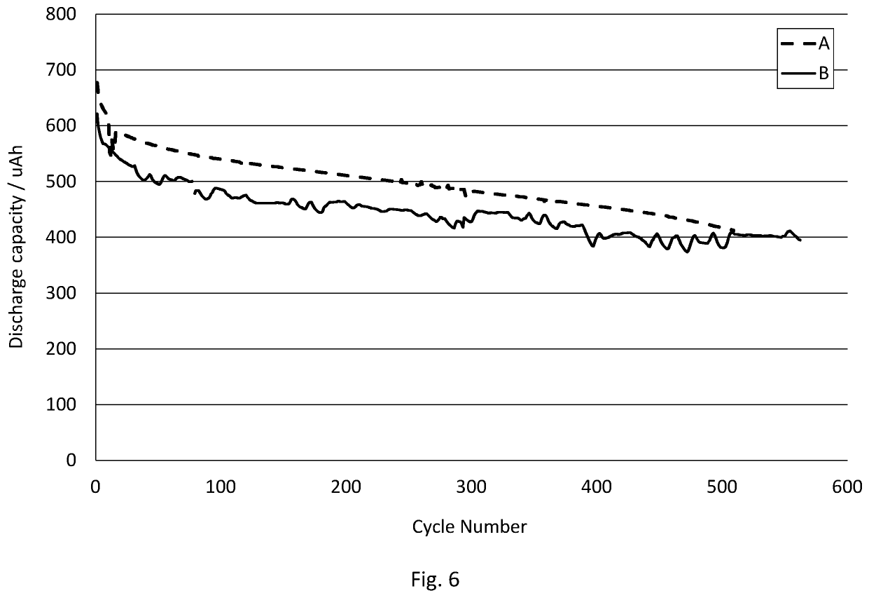

FIG. 6 shows graphs of discharge capacity as a function of cycle number for first and second electrochemical cells according to a fourth embodiment of the first aspect of the invention, the first cell being tested in air and the second cell being tested in argon;

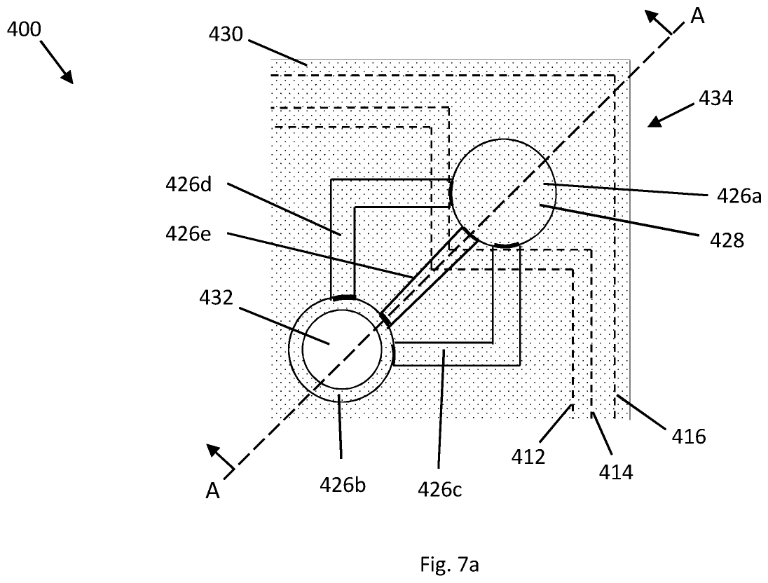

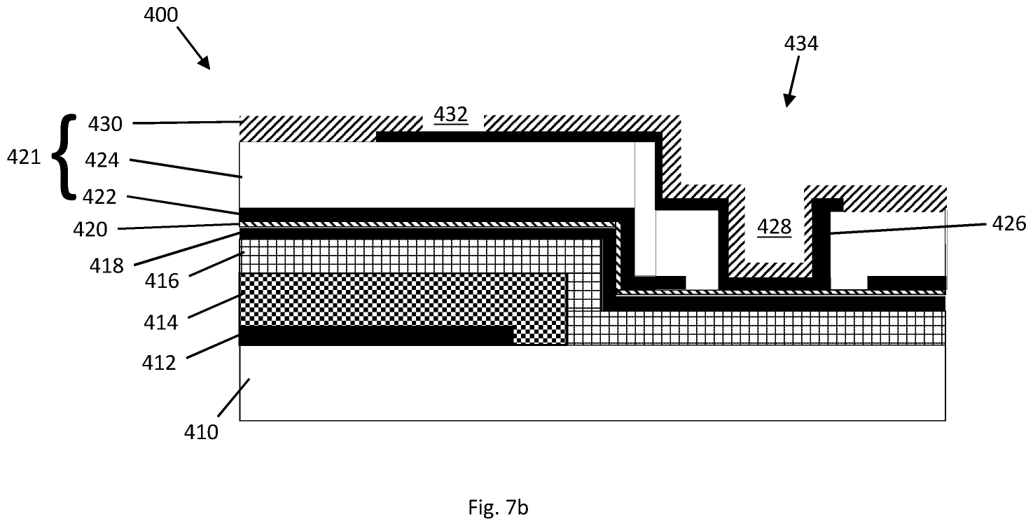

FIG. 7a shows a schematic plan view of a part of a cell according to a fifth embodiment of the first aspect of the invention. For simplicity, the elements of the cell are shown as being transparent, so as to allow the configuration of underlying elements to be seen;

FIG. 7b shows a schematic cross-sectional view of the cell of FIG. 7a, taken along the line A-A.

Referring to FIG. 1a, in a first stage of the manufacture of a cell according to a comparative example, an assembly of cell components is provided comprising a current collector layer 12 and a protective cover 102.

The protective cover 102 comprises an electrically-insulating ceramic passivation layer 14 immediately adjacent the current collector layer 12, and polymer layers 104,108,112 arranged in an alternating sequence with metal layers 106,110,114.

An aperture 116 is provided in the passivation layer. The polymer layer 104 immediately adjacent the passivation layer 14 extends through the aperture 116 in the passivation layer and to contact the current collector layer 12.

The current collector layer 12 may be provided by a material selected from the group consisting of platinum, nickel, molybdenum, copper, titanium nitride, aluminium, gold and stainless steel. The second face of the current collector layer 12 (that is, the face that is opposed to the passivation layer 14) contacts a core battery stack comprising first and second electrode layers 6,10 having an electrolyte layer 8 located therebetween.

Referring to FIG. 1b, in a second stage of the manufacture of a cell according to a comparative example of the invention, a through thickness portion of the section of the protective cover 102 overlying aperture 116 in the passivation layer 14 is removed, so as to expose a section of the current collector layer 12.

In the configuration shown in FIG. 1b, the through-thickness portion that is removed covers a greater area than aperture 116, so that part of the passivation layer 14 is exposed. However, in other configurations, the through-thickness portion that is removed covers a smaller area than the aperture in the passivation layer, so that the exposed section of current collector layer 12 lies within the aperture and the walls of aperture remain coated by the polymer layer.

The exposed section of the current collector layer 12 may provide a contact pad to allow connection of the cell to external devices. Typically, this requires a wire to be bonded to the contact pad.

However, it has been found that during cycling of a cell having a contact pad arranged according to this configuration, a change is observed in the appearance of the contact pad, thought to be due to the presence of reaction products at the exposed surface of the current collector layer 12. These reaction products are considered to impede the bonding between the wire and the contact pad, such that electrical contact may be lost after only a few cycles of the cell (in certain cases, electrical contact may be lost after the cell has undergone only three cycles).

The formation of reaction products on the contact pad (that is, at the exposed surface of the current collector layer 12) is thought to be due to the diffusion of species from the battery stack underlying the current collector layer 12 to the contact pad, where these species react with the ambient environment.

Referring to FIG. 2, a cell 328 according to a second comparative example of the invention comprises a stack of layers deposited on a substrate 314.

The stack of layers comprises the following layers arranged in the following order: an adhesion layer 316, located immediately adjacent the substrate 314, a cathode current collector layer 318, a cathode layer 320, an electrolyte layer 322, an anode layer 324, and an anode current collector 326.

The external surface of the stack of layers is covered by an electrically-insulating encapsulating layer 330, with the exception of a section of the anode current collector 326 that lies within a through-thickness aperture 332 in the encapsulating layer, and a section of cathode current collector layer 318. Following formation of the aperture 332, a metal track layer 334 is deposited over the outer surface of the cell 328.

The metal track layer 334 provides a conductive path from the anode current collector 326 to the substrate 314, where a contact pad may be provided (not shown). The contact pad enables connection of the cell 328 to an external device (not shown).

However, during operation of the cell, it is likely that one or more layers within the stack of layers will undergo changes in thickness. For example, in the case that the cell is a lithium-ion cell, the anode layer will tend to swell during charging of the cell, as lithium ions become embedded in it. Conversely, the anode layer will tend to shrink during discharge of the cell, as lithium ions leave the layer.

It is thought that these changes in volume of the layers during operation of the cell will have a negative impact on the integrity of the metal track layer 334 that connects the anode current collector 326 to the substrate 314, thus reducing the reliability of the conductive pathway that it provides.

Referring to FIG. 3a, in a first stage of the manufacture of a cell according to a first embodiment of the invention, an assembly of cell components is provided comprising a current collector layer 12, an electrically-insulating ceramic passivation layer 14, and a first polymer layer 18. The passivation layer 14 is disposed on a first face of the current collector layer 12. The first polymer layer 18 is disposed on the face of the passivation layer 14 that is opposed to the current collector layer 12.

An aperture 16 is provided in the passivation layer. The first polymer layer 18 extends through the aperture 16 to contact the current collector layer 12.

The current collector layer 12 may be provided by a material selected from the group consisting of platinum, nickel, molybdenum, copper, titanium nitride, aluminium, gold and stainless steel. The second face of the current collector layer 12 (that is, the face that is opposed to the passivation layer 14) typically contacts a core battery stack (not shown), the core battery stack comprising first and second electrode layers having an electrolyte layer located therebetween. However, in certain cases, the cell may be manufactured such that, initially, no electrode layer is provided between the current collector layer 12 and the electrolyte layer of the cell (not shown). In such cases, the cell is typically configured such that during the first charging of the cell, a lithium anode is formed between the electrolyte and the current collector layer 12.

The passivation layer 14 is typically provided by a ceramic material, for example, a material selected from the group consisting of aluminium oxide and aluminium nitride. In certain embodiments, the passivation layer has a thickness of about 1.5 μm.

In certain cases, the first polymer layer 18 may be provided by a poly(p-xylylene) polymer, such as parylene™. In other cases, the polymer layer may be provided by a photoresist material, that is, a material that undergoes chemical changes in response to incident light, these chemical changes altering its solubility in certain solvents. The photoresist material may contain an epoxy resin.

The thickness of the first polymer layer 18 is typically 5 μm (this refers to the thickness of the portion of the first polymer layer that overlies the passivation layer 14).

The aperture 16 in the passivation layer 14 is typically formed through an etching process prior to deposition of the first polymer layer 18.

Referring to FIG. 3b, in a second stage of the manufacture of the cell, the assembly of cell components shown in FIG. 3a is modified to create an aperture 20 in the section of the first polymer layer 18 that overlies the aperture 16 in the passivation layer 14. Thus, a portion of the first surface of the current collector layer 12 is exposed.

The aperture 20 is typically created through a photolithography process. In certain cases, this photolithography process may comprise depositing a photoresist layer on the exposed surface of the first polymer layer 18 and exposing the photoresist layer to a pattern of light that causes chemical changes within certain portions of the layer. A solvent (that is, a developer solution) may then be applied to the photoresist layer, whose effect varies depending on the chemical changes caused by the light pattern (for example, a positive tone photoresist layer becomes more soluble in developer solution after exposure to UV light, while a negative photoresist layer becomes less soluble in developer solution after exposure to UV light). Thus, a masking layer may be provided on the surface of the first polymer layer 18, allowing etching to be performed to create aperture 20.

However, in the case that the first polymer layer 18 is provided by a photoresist material, the aperture 20 may be created without the need to provide a separate masking layer, since the layer may be exposed directly to the light and the solvent in order to create the aperture.

The aperture 20 formed in the first polymer layer 18 is typically narrower than the aperture 16 provided in the passivation layer 14. As a result, the internal surfaces of aperture 16 are typically covered with a coating of the material of first polymer layer 18.

Referring to FIG. 3c, in a third stage of the manufacture of the cell, a first electrically-conductive layer 22 is deposited over the exposed surface of the assembly of cell components shown in FIG. 3b. The first electrically-conductive layer 22 follows the profile of the exposed surface of the assembly of FIG. 3b, and hence covers the surface of the first polymer layer 18 that is opposed to the passivation layer 14, as well as the internal surfaces of aperture 20 and the section of the current collector layer 12 that was exposed during the formation of aperture 20.

The first electrically-conductive layer 22 typically comprises aluminium or titanium nitride. The thickness of the first electrically-conductive layer is typically 200 nm. In the case that the first electrically-conductive layer 22 is provided by an aluminium layer, the deposition of the first electrically-conductive layer 22 typically comprises a sputtering process.

Following the deposition of the first electrically-conductive layer 22, a second polymer layer 24 is deposited on the exposed surface of the first electrically-conductive layer 22. The second polymer layer 24 therefore follows the profile of the exposed surface of the first electrically-conductive layer 22. The second polymer layer 24 typically has the same composition as the first polymer layer 18, and is typically deposited to the same thickness.

Referring to FIG. 3d, in a fourth stage of the manufacture of the cell, the assembly of cell components shown in FIG. 3c is modified to provide an aperture 26 in the second polymer layer 24. The aperture 26 is created in a portion of the second polymer layer 24 that overlies a section of the passivation layer 14. Aperture 26 is a through-thickness aperture in the second polymer layer 24, and thus the formation of the aperture has the effect of exposing a section of the first electrically-conductive layer 22.

Aperture 26 is typically created through the same procedure as aperture 20 of FIG. 3b.

Referring to FIG. 3e, in a fifth stage of the manufacture of the cell, a second electrically-conductive layer 28 is deposited over the exposed surface of the assembly of cell components shown in FIG. 3d. The second electrically-conductive layer 28 follows the profile of the exposed surface of the assembly of FIG. 3d. The second electrically-conductive layer 28 typically has the same composition and thickness as the first electrically-conductive layer 22, and is deposited using the same process. However, this is not always the case.

After the deposition of the second electrically-conductive layer 28, a third polymer layer 30 is deposited on the exposed surface of the second electrically-conductive layer 28. The third polymer layer 30 typically has the same composition as the first and second polymer layers 18, 24, and is typically deposited to the same thickness.

Referring to FIG. 3f, in a sixth stage of the manufacture of the cell, the assembly of cell components shown in FIG. 3e is modified to provide an aperture in the third polymer layer 30. This aperture is a through-thickness aperture of the third polymer layer 30 and exposes a portion 32 of the second electrically-conductive layer 28 that is aligned with the current collector layer 12. This portion 32 of the second electrically-conductive layer 28 provides a contact pad that allows the cell to be connected to an external device.

Thus, as a result of the process described with reference to FIGS. 3a-f, a protective cover has been provided that overlies current collector layer 12. This protective cover is provided by passivation layer 14, along with first, second and third polymer layers 18,24,30, which are arranged in generally alternating configuration with first and second electrically-conductive layers 22, 28. In general, the second polymer layer 24 is disposed between the first and second electrically-conductive layers 22,28. However, the first and second electrically-conductive layers 22,28 coincide along a portion 25 of their length, and along this portion, the two conductive layers are not separated by the second polymer layer 24.

The steps of depositing an electrically-conductive layer, depositing a polymer layer and creating an aperture in the polymer layer to expose a section of the electrically-conductive layer (as shown, for example, in FIGS. 3e and 3f) may be repeated as often as necessary to create a protective cover having the desired thickness and/or barrier properties.

It is thought that by providing alternating layers of electrically-conductive material (for example, aluminium) and polymer material, the ingress of moisture into the cell (from the exposed surface of the protective cover towards the current collector layer 12) may be inhibited.

At the same time, an electrically-conductive pathway is provided between the contact pad 32 and the current collector layer 12. This electrically-conductive pathway follows the second electrically-conductive layer 28 from the contact pad to the region 25 where the first and second electrically-conductive layers 22,28 coincide, and subsequently follows the first electrically-conductive layer 22 to the current collector layer 12.

As may be seen from FIG. 3f, the electrically-conductive pathway from the current collector layer 12 to the contact pad 32 is not direct. Instead, it doubles back on itself multiple times.

It is thought that the provision of this tortuous pathway helps to reduce the extent of diffusion of species from the core battery stack underlying the current collector layer 12 to the contact pad 32. This is thought to help to impede the formation of reaction products at the contact pad 32 that might interfere with the connection of the cell to an external device.

Referring to FIG. 4a, in a first stage of the manufacture of a cell according to a second embodiment of the invention, an assembly of cell components is provided comprising a current collector layer 12, an electrically-insulating ceramic passivation layer 214, and a first polymer layer 218. The passivation layer 214 is disposed on a first face of the current collector layer 12. The first polymer layer 218 is disposed on the face of the passivation layer 214 that is opposed to the current collector layer 12.

One or more electrode and/or electrolyte layers (not shown) are disposed on the side of the current collector layer 12 that is opposed to the passivation layer 14.

The composition and thickness of the passivation layer 214 are typically the same as for the passivation layer 14 shown in FIGS. 3a-f. The first polymer layer 218 typically has the same composition as the first polymer layer 18 shown in FIGS. 3a-f, and a thickness of 5 μm.

Multiple apertures are provided through the thickness of the passivation layer 214 and the first polymer layer 218, such that multiple portions 220 of the face of the current collector layer 12 that contacts the passivation layer 214 are exposed.

Referring to FIG. 4b, in a second stage of the manufacture of the cell, a first electrically-conductive layer 222 is deposited over the exposed surface of the assembly of cell components shown in FIG. 4a. The first electrically-conductive layer 222 follows the profile of the exposed surface of the assembly of FIG. 4a. Thus, the first electrically-conductive layer is deposited directly on the current collector layer 12 at the exposed portions 220 of the current collector layer 12.

The first electrically-conductive layer 222 typically has the same composition and thickness as the first and second electrically-conductive layers 22,28 shown in FIGS. 3e and 3f, although this is not always the case.

Referring to FIG. 4c, in a third stage of the manufacture of the cell, a second polymer layer 224 is deposited over the exposed surface of the assembly of cell components shown in FIG. 4b. The second polymer layer 224 typically has the same composition and is deposited to the same thickness as the first polymer layer 218. Following the deposition of the second polymer layer 224, multiple apertures are created through the thickness of this layer, so as to provide multiple exposed portions 226 of the first electrically-conductive layer. The apertures may be created through a photolithography process as described in relation to FIG. 3b. The exposed portions 226 of the first electrically-conductive layer 222 each have a surface that faces away from the current collector layer 12. A respective portion of the first polymer layer 218 lies between each exposed portion 226 of the first electrically-conductive layer 222 and the passivation layer 214.

Referring to FIG. 4d, in a fourth stage of the manufacture of the cell, a second electrically-conductive layer 228 is deposited over the exposed surface of the assembly of cell components shown in FIG. 4c. The second electrically-conductive layer 228 follows the profile of the exposed surface of the assembly of FIG. 4c. Thus, the second electrically-conductive layer 228 is deposited directly on the first electrically-conductive layer 222 at the exposed portions 226 of the first electrically-conductive layer 222.

The second electrically-conductive layer 228 typically has the same composition and thickness as the first electrically-conductive layer 222, although this is not always the case.

Referring to FIG. 4e, in a fifth stage of the manufacture of the cell, a third polymer layer 230 is deposited over the exposed surface of the assembly of cell components shown in FIG. 4d. The third polymer layer 230 typically has the same composition and is deposited to the same thickness as the first polymer layer 218. Following the deposition of the third polymer layer 230, multiple apertures are created through the thickness of this layer, so as to provide multiple exposed portions 232 of the second electrically-conductive layer 228. The apertures may be created through a photolithography process as described in relation to FIG. 3b. The exposed portions 232 of the second electrically-conductive layer 228 each have a surface that faces away from the current collector layer 12. A respective portion of the second polymer layer 228 lies between each exposed portion 232 of the second electrically-conductive layer 230 and the passivation layer 214.

Each exposed portion 232 of the second electrically-conductive layer 230 provides a contact pad, allowing connection of the cell to an external device.

It is thought that by providing alternating layers of electrically-conductive material (for example, aluminium) and polymer material, a protective cover 234 is formed that helps to inhibit the ingress of moisture into the cell from the exposed surface of the protective cover 234 towards the current collector layer 12.

The steps of depositing an electrically-conductive layer, depositing a polymer layer and creating apertures in the polymer layer, as described with reference, for example, to FIGS. 4d and 4e, may be repeated if necessary to build up a protective cover of the desired thickness.

At the same time, multiple electrically-conductive pathways are provided between each contact pad (at the respective exposed section 232 of the second electrically-conductive layer 228) and the current collector layer 12. These electrically-conductive pathways follow the second electrically-conductive layer 228 from the contact pad to a region where the first and second electrically-conductive layers 222,228 coincide, and subsequently follow the first electrically-conductive layer 222 to the current collector layer 12.

The provision of multiple contact pads and multiple electrically-conductive pathways connecting each contact pad to the current collector layer 12 provides redundancy within the cell, such that the cell can continue to be connected to an external device even if a single electrically-conductive pathway between a contact pad and the current collector layer 12 fails.

As may be seen from FIG. 4e, none of the electrically-conductive pathways provided from the current collector layer 12 to the contact pads provided at the exposed sections 232 of the second electrically-conductive layer 228 is direct. Instead, each electrically-conductive pathway changes direction through 90° at least once, and in certain cases, an electrically-conductive pathway may double back on itself. It is thought that the provision of such pathways helps to reduce the extent of diffusion of species from electrode or electrolyte layers underlying the current collector layer 12 to the contact pads provided by the exposed sections 232 of the second electrically-conductive layer 228. This is thought to help to impede the formation of reaction products at the contact pads that might interfere with the connection of the cell to an external device.

Referring to FIG. 5a, an assembly of cell components is provided that corresponds to that shown in FIG. 1b (for simplicity, the core battery stack of FIG. 1b, comprising electrode layers 6,10 and electrolyte layer 8 is not shown). That is, a current collector layer 12 has a protective cover 102 disposed on a first face thereof, the protective cover 102 comprising an electrically-insulating ceramic passivation layer 14 that is immediately adjacent the current collector layer 12, as well as polymer layers 104,108,112 arranged in an alternating sequence with metal layers 106,110,114.

A through-thickness apertures is provided in the protective cover 102, so that a portion 118 of the current collector layer 12 is exposed. This may provide a contact pad for connecting to cell to an external device.

The assembly of FIG. 5a may be modified to provide a contact pad on an external surface of protective cover 102, rather than directly on the current collector layer 12. This process is shown with reference to FIGS. 5b-e.

Referring to FIG. 5b, in a first step of adapting the assembly of FIG. 5a, a first electrically-conductive layer 120 is deposited, which covers the exposed surface 118 of the current collector layer 12, as well as the internal surfaces of through-thickness aperture provided in the protective cover 102. This assists in sealing the internal surface of the through-thickness aperture provided in the protective cover 102, so as to inhibit ingress of atmospheric constituents between the layers.

Referring to FIG. 5c, in a second step of adapting the assembly of FIG. 5a, the portion of the first electrically-conductive layer 120 that contacted the surface of the current collector layer 12 and the internal surface of the aperture provided in the passivation layer 14 is removed, for example, through an etching process. This reduces the risk of a short-circuit between the current collector layer 12 and the metal layers in the protective cover 102.

Referring to FIG. 5d, in a third step of adapting the assembly of FIG. 5a, a first polymer layer 122 is deposited over the exposed surface of the assembly of cell components shown in FIG. 5c, and is subsequently etched to expose the surface of the current collector 12.

Referring to FIG. 5e, in a fourth step of adapting the assembly of FIG. 5a, a second electrically-conductive layer 124 is deposited over the exposed surface of the assembly of cell components shown in FIG. 5d. The first polymer layer 122 provides an electrically-insulating layer between the first and second electrically-conductive layers 120,124.

Referring to FIG. 5f, in a fifth step of adapting the assembly of FIG. 5a, a second polymer layer 126 is deposited over the exposed surface of the assembly of cell components shown in FIG. 5e. A through-thickness aperture is then provided in a portion of the second polymer layer 126 on the external face of protective cover 102. This aperture exposes a section of the second electrically-conductive layer 124, so as to provide a contact pad 128.

Referring to FIG. 6, curves A and B show discharge capacity as a function of cycle number for cells according to a fourth embodiment of the first aspect of the invention. Curve A was obtained from testing carried out in air, while curve B was obtained from testing carried out under an argon atmosphere. As can be seen from the graph, similar capacity loss is observed in both cases, demonstrating that the protective cover is effective in shielding the active layers of the cell from moisture and other atmospheric constituents.

Referring to FIGS. 7a and 7b, a cell 400 has a substrate 410 on which are stacked, in order, a cathode current collector 412, a cathode 414, an electrolyte 416, an anode 418, and an anode current collector 420 (for simplicity, substrate 410, anode 418 and anode current collector 420 are not shown in FIG. 7a). The cathode current collector 412 and the cathode layer 414 do not extend fully into the corner portion 434 of the cell, and so in that corner portion, the electrolyte 416 is in direct contact with the substrate 410.

As shown in FIG. 7b, the cell further includes a protective cover 421, which comprises an electrically-insulating passivation layer 422 that is immediately adjacent the anode current collector 420, a stack of alternating polymer and metal layers, which is shown generally as feature 424 (for simplicity, the individual metal and polymer layers are not shown), and outer polymer layer 430.

An aperture 428 is provided in the corner portion 434 of the cell 400, the aperture extending through the stack of alternating polymer and metal layers 424 and the electrically-insulating passivation layer 422 (for simplicity, details of the configuration of the internal wall of aperture 428 are not shown, but these are generally similar to those shown in FIG. 5f). An electrically-conductive trace 426 overlies the stack of alternating polymer and metal layers 424 and contacts the anode current collector layer 420 at the aperture 428.

As shown with reference to FIGS. 7a and 7b, the electrically-conductive trace 426 comprises a first circular portion 426a at the location of the aperture 428, a second circular portion 426b overlying the stack of alternating polymer and metal layers 424, and three legs 426c,d,e connecting the first and second circular portions.

The outer polymer layer 430 overlies the stack of alternating polymer and metal layers 424 and the electrically-conductive trace 426, the outer polymer layer 430 comprising an aperture 432 in the region overlying the second circular portion 426b of the electrically-conductive trace 426.

The exposed section of the electrically-conductive trace 426 at the location of the aperture 432 provides a contact pad, allowing the cell to be connected to an external device.

Since aperture 428 is provided in the corner portion 434 of the cell 400, it does not overlie the cathode layer 414. It is thought that this helps to prevent cracking of the electrically-conductive trace 426 at the location of the aperture 428, which might otherwise occur through migration of chemical species (for example, lithium) from the cathode 414 to the aperture 428.

By providing an electrically-conductive trace 426 having three legs 426c,d,e connecting the first and second circular portions 426a,b, an electrical connection may be maintained between the first and second circular portions even if one or two of the legs 426c,d,e fail. This redundancy is beneficial, since the thickness of the electrically-conductive trace 426 is only about 200 nm and the legs may be vulnerable, for example, at the edge between the internal wall of aperture 428 and the stack of alternating polymer and metal layers 424. The use of a thicker electrically-conductive trace 426 is not desirable, since the trace is formed by depositing a layer of the electrically-conductive material and etching it to provide the required configuration. Care must be taken during etching to avoid leaving residual electrically-conductive material that may create a short-circuit between different sections of the cell, and this is more difficult with a thicker trace.

For the avoidance of doubt, the terms “overlying,” “overlie,” “underlying,” and “underlie” refer to the relative positions of cell components when the assembled cell components are oriented as shown in FIGS. 1-5 and 7b.

1. An electrochemical cell comprising at least the following layers stacked in the following order:
a first electrode layer, an electrolyte layer, a second electrode layer, a current collector layer, and a protective cover;
the protective cover comprising an electrically-insulating material;
the cell further comprising an electrically-conductive contact pad that is configured to enable connection of the cell to external devices, the contact pad being provided on an external side of the protective cover that is opposed to the current collector layer, and comprising an exposed surface that is bounded about its perimeter by the electrically-insulating material;
wherein an electrically-conductive pathway is provided between the contact pad and the current collector layer, the electrically-conductive pathway extending through the protective cover and contacting a face of the current collector layer at a connection site.

2. A cell according to claim 1, wherein at least a portion of the electrically-conductive pathway extends in a direction that is not perpendicular to the face of the current collector layer.

3. A cell according to claim 2, wherein at least a portion of the electrically-conductive pathway is oriented at an angle of 80° or less relative to the face of the current collector layer.

4. A cell according to claim 2, wherein the contact pad is offset from the connection site in a lateral direction of the current collector layer.

5. A cell according to claim 1, wherein the electrically-conductive pathway follows an indirect route between the connection site and the contact pad.

6. A cell according to claim 5, wherein the electrically-conductive pathway changes direction through an angle in the range 80-100° between the connection site and the contact pad.

7. A cell according to claim 5, wherein the electrically-conductive pathway follows a zigzag route between the connection site and the contact pad.

8. A cell according to claim 1, wherein the electrically-conductive pathway and the contact pad are integrally formed.

9. A cell according to claim 1, wherein at least one of the electrically-conductive pathway and the contact pad comprises a material selected from the group consisting of aluminium, platinum, molybdenum, copper, nickel, gold, stainless steel and titanium nitride.

10. A cell according to claim 1, wherein the electrically-conductive pathway has a thickness in the range 20-2000 nm.

11. A cell according to claim 1, wherein the contact pad is located within the footprint of the cell, the footprint of the cell being bounded by the perimeter of the electrolyte layer.

12. A cell according to claim 1, wherein the connection site is offset from the first electrode layer in a lateral direction of the first electrode layer.

13. A cell according to claim 1, wherein the first electrode is a cathode.

14. A cell according to claim 1, wherein the cell comprises a further contact pad that is electrically-connected to the first electrode, wherein an imaginary line extending directly between the contact pad and the further contact pad passes through at least one of the first electrode, the electrolyte, the second electrode, and the current collector layer.

15. A cell according to claim 1, wherein the protective cover comprises a plurality of first layers and a plurality of second layers, the first layers each being provided by a polymeric material and the second layers each being provided by one of a metal and a ceramic material, wherein the first and second layers are arranged in a stacked configuration to provide alternating first and second layers.

16. A cell according to claim 15, wherein at least one of the second layers is provided by an electrically-conductive material and a portion of the electrically-conductive pathway extends along that second layer.

17. A cell according to claim 15, wherein at least one of the first layers comprises a poly(p-xylylene) polymer.

18. A cell according to claim 15, wherein at least one of the first layers comprises a photoresist material, for example a photoresist material comprising an epoxy resin.

19. A cell according to claim 1, wherein the protective cover comprises an electrically-insulating passivation layer immediately adjacent to the current collector layer.

20. A cell according to claim 1, wherein at least one further electrically-conductive pathway is provided between the contact pad and the connection site.

21. A cell according to claim 1, wherein the cell comprises a plurality of electrically-conductive pathways, each pathway being associated with a respective connection site at which the pathway contacts the current collector layer, and each pathway extending through the protective cover to reach one of one or more contact pads that are provided on the side of the protective cover that is opposed to the current collector layer.

22. A cell according to claim 1, wherein the cell comprises a plurality of contact pads provided on the side of the protective cover that is opposed to the current collector layer, each of the plurality of contact pads being associated with a respective electrically-conductive pathway that extends between the respective contact pad and the current collector layer.

23. A cell according to claim 1, wherein the footprint of the cell is less than 500 mm².

24. An electrochemical cell according to claim 1, wherein the electrochemical cell is a solid state electrochemical cell.

25. An electrochemical cell according to claim 1, wherein the electrochemical cell is a lithium-ion cell.

26. A precursor for an electrochemical cell according to claim 1, the precursor comprising a stack of layers including a cathode layer, an electrolyte layer, a current collector layer, and a protective cover, the protective cover being located on a first side of the current collector layer, and the cathode layer and electrolyte layer being located on a second side of the current collector layer;
wherein the protective cover comprises an electrically-insulating material;
the cell further comprising an electrically-conductive contact pad that is configured to enable connection of the cell to external devices, the contact pad being provided on an external side of the protective cover that is opposed to the current collector layer, and comprising an exposed surface that is bounded about its perimeter by the electrically-insulating material;
wherein an electrically-conductive pathway is provided between the contact pad and the current collector layer, the electrically-conductive pathway extending through the protective cover and contacting a face of the current collector layer at a connection site.

27. A method of manufacturing a cell according to claim 1, comprising the steps of:
Providing a stack of layers comprising at least the following layers: a cathode layer, an electrolyte layer, a current collector layer, and a first electrically-insulating layer, the first electrically-insulating layer being located on a first side of the current collector layer, and the cathode layer and electrolyte layer being located on a second side of the current collector layer;
Providing an aperture through the thickness of the first electrically-insulating layer, such that a portion of a face of the current collector is exposed; and
Depositing an electrically-conductive material on the exposed section of the current collector layer and at least a portion of the first electrically-insulating layer, so as to create an electrically-conductive pathway between the exposed portion of the face of the current collector layer and the surface of the first electrically-insulating layer that is opposed to the current collector layer.

28. A method according to claim 27, wherein the step of providing an aperture through the thickness of the first electrically-insulating layer comprises etching the first electrically-insulating layer.

29. A method according to claim 28, wherein the first electrically-insulating layer comprises a photoresist material and the step of etching the first electrically-insulating layer comprises exposing at least one part of the surface of the first electrically-insulating layer to incident light that causes chemical changes within that part of the surface of the first electrically-insulating layer.

30. A method according to claim 27, further comprising the step, after the step of creating the electrically-conductive pathway, of depositing a second electrically-insulating layer over the first electrically-insulating layer and creating a through-thickness aperture through the second electrically-insulating layer, so as to expose a portion of the electrically-conductive pathway, the through-thickness aperture in the second electrically-insulating layer being displaced from the through-thickness aperture in the first electrically-insulating layer in a lateral direction of the second electrically-insulating layer.
